(19) United States
(12) Patent Application Publication
(10) Pub. No.: US 2007/0153915 A1
(43) Pub. Date: Jul. 5, 2007

(54) DIGITAL MEDIA MIXER AND METHOD THEREOF

(75) Inventors: Chun-Chin LIN, Chung Ho City (TW); Jiun-Kuei JUNG, Chung Ho City (TW)

Correspondence Address: GLENN PATENT GROUP, 3475 EDISON WAY, SUITE L, MENLO PARK, CA, 94025, US

(73) Assignee: AverMedia TECHNOLOGIES, INC., Chung Ho City (TW)

(21) Appl. No.: 11/380,843

(22) Filed: Apr. 28, 2006

(30) Foreign Application Priority Data
Jan. 3, 2006 (TW) 95100223

(51) Int. Cl. H04N 7/12; H04N 11/02

(52) U.S. Cl. 375/240.26; 348/385.1

(57) ABSTRACT

The present invention provides a digital media mixer including a plurality of analog-to-digital converters for transforming analog audio/video signals to digital audio/video signals, a plurality of encoders for encoding the digital audio/video signals, a multiplexer for mixing the encoded digital audio/video signals using an MPEG-2 TS format, and a network interface for transferring the mixed digital audio/video signals by a broadcast technology or a multicast technology.

### RELATED APPLICATIONS

The present application is based on, and claims priority from, Taiwan Application Serial Number 95100223, filed Jan. 3, 2006, the disclosure of which is hereby incorporated by reference herein in its entirety.

### FIELD OF THE INVENTION

The present invention relates to an apparatus and method to broadcast audio/video signals, and more particularly, to an apparatus and method that can conserve bandwidth to broadcast audio/video signals.

### BACKGROUND OF THE INVENTION

With developments in wide-band technologies, it has become a trend to watch digital TV programs through wide-band networks.

Typically, a user has to send out a channel requirement signal to a digital TV host through a network. Then, related channel information is sent back to the user. The user can then see the programming of the channel in the display.

According to the typical communication framework, a plurality of point-to-point communication paths has to be built between the host and each receiver respectively for transferring the channel information. In other words, even though two receivers send out the same channel requirement signal to the host, two communication paths still have to be built between the host and each of the two receivers for transferring the channel information. Such Framework occupies a lot of bandwidth. Moreover, same communication equipment has to be installed in each receiver for performing point-to-point communication, which raises hardware costs.

Therefore, a communication framework and a communication method are required to solve the foregoing problem.

### SUMMARY OF THE INVENTION

Therefore, it is the main purpose of the present invention to provide a digital media mixer and method thereof for conserving bandwidth.

Another purpose of the present invention is to provide a digital media mixer that can reduce hardware cost.

According to a preferred embodiment, the digital media mixer includes a plurality of analog-to-digital converter for transforming analog audio/video signals to digital audio/video signals, a plurality of encoder for encoding the digital audio/video signals, a multiplexer for mixing the encoded digital audio/video signals based on a MPEG-2 TS format and a network interface for transferring the mixed digital audio/video signals by a broadcast technology or a multicast technology.

In another embodiment, the digital media mixer includes a plurality of analog-to-digital converters for transforming analog audio/video signals to digital audio/video signals, a plurality of encoders for encoding the digital audio/video signals, at least one tuner for receiving channel information to tune a channel required by a user, at least one de-multiplexer for resolving the channel information, a multiplexer for mixing the encoded digital audio/video signals and the resolved channel information based on an MPEG-2 TS format, and a network interface for transferring the mixed digital audio/video signals by a broadcast technology or a multicast technology.

In another embodiment, the digital media mixer further comprises a receiver for receiving a requirement signal from a user and a controller to control the tuner to tune a channel based on the requirement signal.

Moreover, the present invention also provides a method for transferring digital signals. First, a channel is tuned based on a channel requirement signal. Next, all analog audio/video signals are transformed to digital audio-video signals. Finally, all digital audio/video signals are mixed together based on an MPEG-2 TS format. Then, the mixed digital audio/video signals are sent out based on a broadcast technology or a multicast technology.

Accordingly, all the digital audio/video signals are mixed together to transfer to receivers based on a broadcast technology or a multicast technology. Therefore, same audio/video information does not need to be mixed twice, which conserves bandwidth. Moreover, a point-to-point transferring method does not need to be used in the present invention. Therefore, it is not necessary to install hardware for performing the point-to-point communication in each receiver, thus reducing the hardware cost.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a schematic diagram of a digital media mixer according to a preferred embodiment of the present invention;

FIG. 2 illustrates an interior schematic diagram of a digital media mixer according to a preferred embodiment of the present invention; and

FIG. 3 illustrates a schematic diagram of a digital media mixer according to another preferred embodiment of the present invention; and

FIG. 4 illustrates a flow chart for transferring the digital signal according to a preferred embodiment of the present invention.

### DETAILED DESCRIPTION OF THE PREFERRED EMBODIMENTS

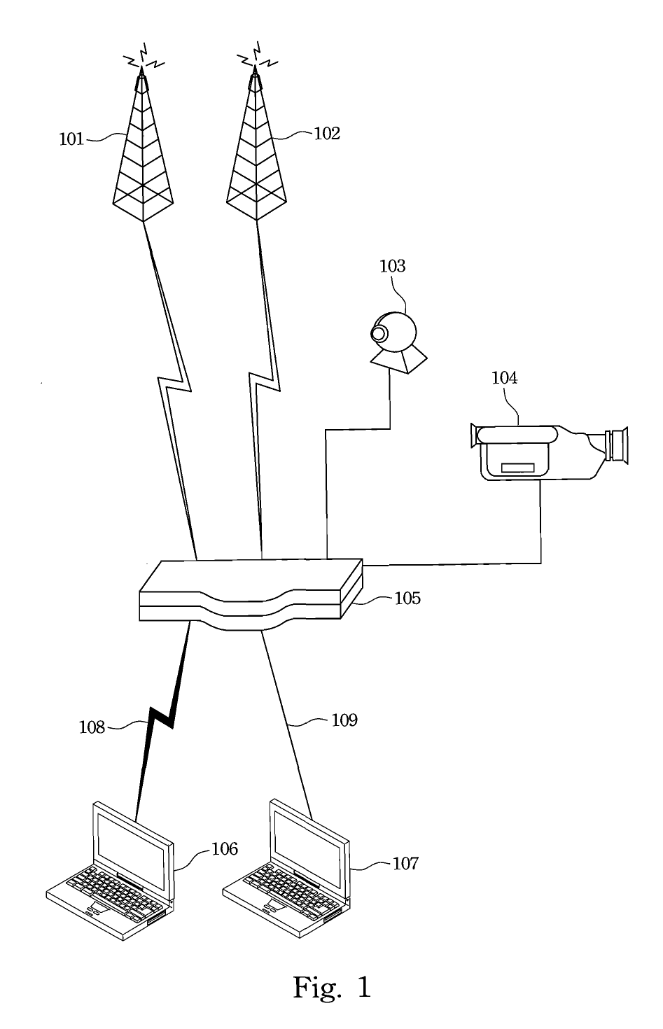

FIG. 1 illustrates a schematic diagram of a digital media mixer according to a preferred embodiment of the present invention. According to the present invention, the media mixer 105 can mix digital audio/video signals generated by different sources, such as TV stations 101 and 102, the camera 103, and the video camera 104. The mixed digital audio/video signals are sent to receivers by wireless transceiver 108 or wire 109. Then, the mixed digital audio/video signals are displayed in the displays of the notebook 106 and 107. It is noticed that other types of digital audio/video signals may also be used in the present invention. Moreover, the number of the audio/video signals processed by the digital media mixer is not limited to four.

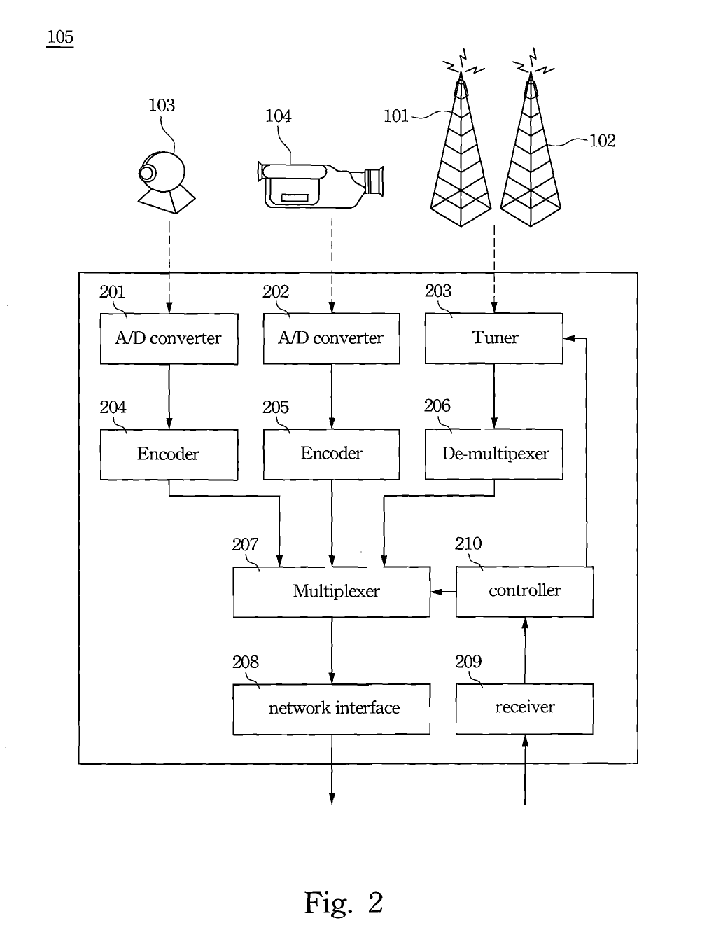

FIG. 2 illustrates an interior schematic diagram of a digital media mixer 105 according to a preferred embodiment of the present invention. Reference is also made to FIG. 1. The digital media mixer 105 can process the audio/video signals generated by the TV stations 101 and 102, the camera 103 and the video camera 104, respectively. The two signals that are generated by the camera 103 and the video camera 104 are analog audio/video signals. Therefore, two analog-to-digital converters 201 and 202 are built in the digital media mixer 105 for transforming the analog audio/video signals to digital audio/video signals. Two encoders 204 and 205 that are connected with the two converters 201 and 202 respectively are used to encode the converted digital audio/video signals.

The signals that are generated by the TV stations 102 and 103 are digital audio/video signals. These digital audio/video signals are MPEG-2 TS formatted no matter whether based on the DVB, ATSC, ISDB or other digital TV standard. In the MPEG-2 TS format, different channels are integrated into one information stream. Therefore, after the tuner 203 tunes the digital audio/video signals, a de-multiplexer 206 is used to resolve this information stream. Finally, a multiplexer 207 mixes the digital audio/video signals from the encoders 204 and 205 and the de-multiplexer 206 using the MPEG-2 TS format. The mixed digital audio/video signals are sent out based on a broadcast technology or a multicast technology.

After the notebook 106 and 107 receive the mixed digital audio/video signals, this signals based on the MPEG-2 TS format are resolved for displaying the required channel in the display. It is noticed that the AVI format or other mixed file format can be used in the present invention. Moreover, a receiver 209 is built in the digital media mixer 105. The main function of the receiver 209 is to receive a channel requirement signal from a user. This requirement signal is used to control a controller 210. This controller 210 can control the tuner 203 to tune a channel based on the requirement signal. On the other hand, this controller 210 can control the multiplexer 207 to mix the signals from the encoders 204 and 205 and the de-multiplexer 206 using the MPEG-2 TS format.

Therefore, according to the present invention, the digital media mixer 105 of the present invention can dynamically mix all required digital audio/video signals into one stream using MPEG-2 TS format or other mixing file format. The mixed signals are sent out using a broadcast technology or a multicast technology to users. The users may resolve the stream to display the required channel. In other words, a user can send out a channel requirement signal to the digital media mixer 105 of the present invention at any time. Then, after the digital media mixer 105 receives this channel requirement signal, it may mix the digital audio/video signal of this required channel into the stream using MPEG-2 TS format or other mixing file format. Then, the mixed signals are sent out to the user. Therefore, according to the present invention, the same digital audio/video signal does not need to be mixed into the stream again. That is, when a user requires a digital audio/video signal that has been mixed in the stream, the digital media mixer 105 can skip this requirement. A same audio/video signal does not be repeatedly mixed. Therefore, the bandwidth is conserved. Moreover, the point-to-point transferring method does not need to be used in the present invention. Therefore, it is not necessary to install hardware for performing the point-to-point communication in each receiver, thereby reducing hardware cost.

It is noticed that, in other embodiments, the analog-to-digital converter can be removed when the digital audio/video signals are only from the TV stations. On the other hand, the tuner 203 and the de-multiplexer 206 may be removed when there is no audio/video signal from the TV stations. Moreover, when the signals from the TV stations 101 and 102 are analog signals, the de-multiplexer 206 can be removed. In this embodiment, the tuner 203 can tune the signals first. Then, the tuned signals are processed as the signals from the camera 103 and video camera 104. On the other hand, the number of the converters and the tuners may be expanded to process more audio/video signals.

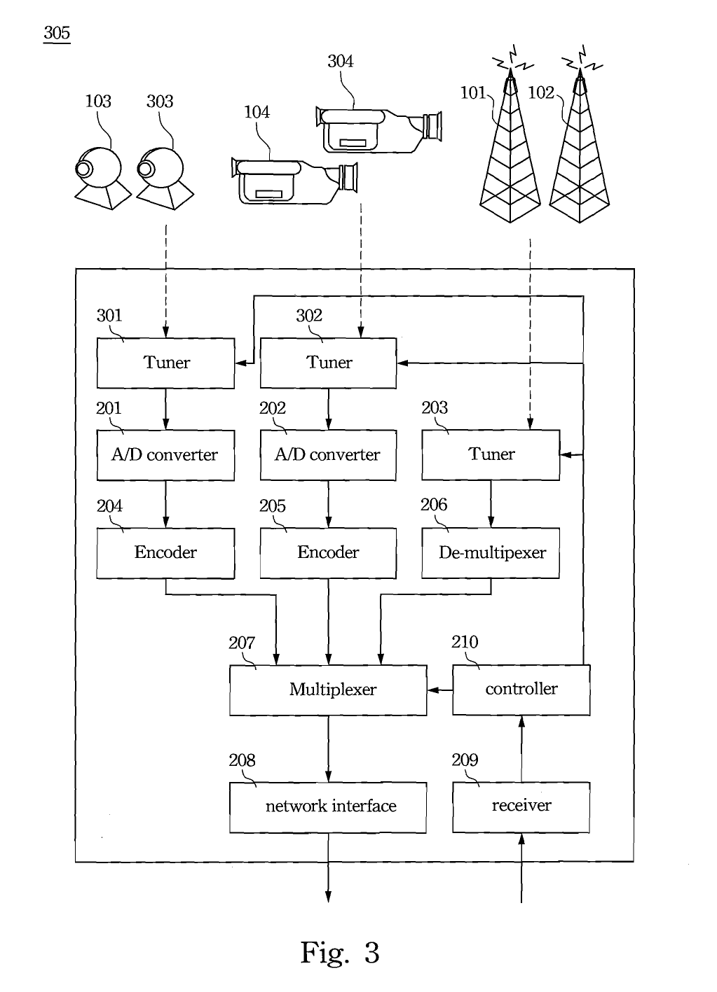

Moreover, the audio/video signals from same type sources may be processed through same process routes. FIG. 3 illustrates a schematic diagram of a digital media mixer 305 that can process the audio/video signals from two cameras 103 and 303 and from two video cameras 104 and 304. Two tuners 301 and 302 controlled by the controller 210 are installed into the digital media mixer 305. The tuner 301 is connected to the analog-to-digital converter 201. The tuner 302 is connected to the analog-to-digital converter 202. The two tuners 301 and 302 can tune channels based on the channel requirement signals issued by the users.

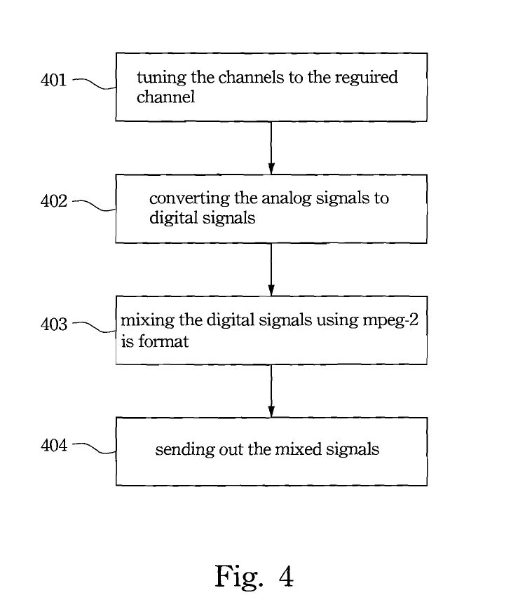

FIG. 4 illustrates a flow chart for transferring the digital signal according to a preferred embodiment of the present invention. Reference is also made to FIG. 2. In the step 401, after a user issues a channel requirement signal, this required channel is tuned by the tuner 203. After the tuner 203 tunes the digital audio/video signals, in step 402, all analog signals are transformed to digital signals by digital-to-analog converters 201 and 202. Alternately, a de-multiplexer 206 is used to resolve this information stream with MPEG-2 TS format. Next, in step 403, a multiplexer 207 mixes the digital audio/video signals from the encoders 204 and 205 and the de-multiplexer 206 using the MPEG-2 TS format. Finally, in step 404, the mixed digital audio/video signals are sent out through a network interface 208 based on a broadcast technology or a multicast technology.

Accordingly, a user can send out a channel requirement signal to the digital media mixer of the present invention at any time. Then, after the digital media mixer receives this channel requirement signal, it may mix the digital audio/video signal of this required channel into the stream. Same audio/video signal does not need to be repeatedly mixed, which can conserve bandwidth. Moreover, a point-to-point transferring method does not need to be used in the present invention. Therefore, it is not necessary to install hardware for performing the point-to-point communication in each receiver, which can reduce hardware cost.

As is understood by a person skilled in the art, the foregoing descriptions of the preferred embodiments of the present invention are illustrations of the present invention rather than limitations thereof. Various modifications and similar arrangements are included within the spirit and scope of the appended claims. The scope of the claims should be accorded to the broadest interpretation so as to encompass all such modifications and similar structures. While preferred embodiments of the invention have been illustrated and described, it will be appreciated that various changes can be made therein without departing from the spirit and scope of the invention.

What is claimed is:

1. A media mixer for mixing at least two audio/video signals and transferring the mixed audio/video signals to at least one user, said mixer comprising:
at least two encoders for encoding said at least two audio/video signals;
a multiplexer for mixing said encoded audio/video signals; and
a transferring apparatus for transferring said mixed audio/video signals to said user.

2. The media mixer of claim 1, further comprising at least one tuner to tune audio/video signals based on requirement signals issued by said user.

3. The media mixer of claim 1, wherein one of said two audio/video signals is a digital signal and a format of said digital signal is an MPEG-2 TS format, an AVI format, or other mixing file format.

4. The media mixer of claim 3, further comprising at least one tuner to tune audio/video signals based on requirement signals issued by said user.

5. The media mixer of claim 4, further comprising at least one de-multiplexer coupling with said at least one tuner to resolve said digital signals to transfer to said user.

6. The media mixer of claim 1, wherein one of said two audio/video signals is an analog signal and said media mixer further comprises at least one analog-to-digital converter to transform said analog signal to digital signal.

7. The media mixer of claim 1, wherein the format of said mixer audio/video signal is an MPEG-2 TS format, an AVI format, or other mixing file format.

8. The media mixer of claim 1, further comprising a receiver to receive a requirement signal from said user.

9. The media mixer of claim 8, further comprising a controller coupling with said receiver to control said tuner to tune said audio/video signal based on said requirement signal from said user.

10. The media mixer of claim 1, wherein said mixed audio/video signal is transferred to said user using a broadcast technology or a multicast technology.

11. The media mixer of claim 1, wherein said mixed audio/video signal is transferred to said user by wireless transceiver or by wire.

12. A media mixing method for mixing at least two, first and second, audio/video signals and transferring the mixed audio/video signals to at least one user, said mixer comprising:
tuning said first audio/video signal based on a requirement signal issued by said user;
resolving said tuned first audio/video signal;
encoding said second audio/video signal;
mixing said encoded second audio/video signal and said resolved first audio/video signal to be a third audio/video signal; and
transferring said third audio/video signal to said user.

13. The media mixing method of claim 12, wherein said second audio/video signal is an analog signal and is from a video camera or from a still-image camera.

14. The media mixing method of claim 13, further comprising tuning said second audio/video signal based on a requirement issued by said user and to transform said tuned second audio/video signal to a digital signal to transfer to encoders.

15. The media mixing method of claim 12, wherein said first audio/video signal is a digital signal and a format of said first audio/video signal is an MPEG-2 TS format, an AVI format, or other mixing file format.

16. The media mixing method of claim 12, wherein a format of said third audio/video signal is an MPEG-2 TS format, an AVI format, or other mixing file format.

17. The media mixing method of claim 12, wherein said third audio/video signal is transferred to said user using a broadcast technology or a multicast technology.

18. The media mixing method of claim 17, wherein said third audio/video signal is transferred to said user by wireless transceiver or by wire.

19. A media mixer for mixing at least two, first and second, audio/video signals and transferring the mixed audio/video signals to at least one user, said mixer comprising:
at least one tuner for receiving said first and second audio/video signals and tuning said first and second audio/video signals based on a requirement signal issued by said user;
at least one de-multiplexer coupling with said tuner to resolve said tuned first audio/video signal;
at least one analog-to-digital converter for transforming said tuned second audio/video signal to a digital second audio/video signal;
at least one encoder coupling with said analog-to-digital converter for encoding said digital second audio/video signal;
a multiplexer for mixing said encoded second audio/video signal and said resolved first audio/video signal to be a third audio/video signal; and
a transferring apparatus for transferring said third audio/video signal to said user.

20. The media mixer of claim 19, wherein said second audio/video signal is from a video camera or from a still-image camera.

21. The media mixer of claim 19, wherein a format of said first audio/video signal is an MPEG-2 TS format, an AVI format, or other mixing file format.

22. The media mixer of claim 19, wherein a format of said third audio/video signal is an MPEG-2 TS format, an AVI format, or other mixing file format.

23. The media mixer of claim 19, further comprising a receiver to receive a requirement signal from said user and a controller coupling with said receiver to control said tuner to tune said first audio/video signal based on said requirement signal from said user.

24. The media mixer of claim 19, wherein said third audio/video signal is transferred to said user by wireless transceiver or by wire.
